(19) United States
(12) Patent Application Publication
(10) Pub. No.: US 2016/0162770 A1
(43) Pub. Date: Jun. 9, 2016

(54) A Land Title Deed Comprising A Smart Chip

(71) Applicant: Kok Ann WONG, Singapore (SG)

(72) Inventor: Kok Ann WONG, Singapore (SG)

(21) Appl. No.: 14/905,965

(22) PCT Filed: Jul. 18, 2014
(86) PCT No.: PCT/SG2014/000342

§ 371 Date: Jan. 19, 2016

(30) Foreign Application Priority Data
Jul. 19, 2013 (SG) 201305535-5

(51) Int. Cl. G06K 19/07; B42D 25/305; G06K 19/077; B42D 25/20

(52) U.S. Cl. CPC G06K 19/0723; B42D 25/20; B42D 25/305; G06K 19/07773

(57) ABSTRACT

The present invention is an electronic land title deed. The electronic land title deed comprises a number of flat sheets; and a smart chip embedded within the flat sheet, wherein the smart chip stores a number of data that provides information related to a land title deed.

### FIELD OF THE INVENTION

The present invention relates to a land title deed. More specifically, the present invention relates to a land title having an electronic chip embedded therein and a method therefor.

### BACKGROUND

A land title deed shows a person's rights to a particular plot of land. The person may be the owner of the plot of land. The land title deed may also include information such as estate and land description, ownership information, encumbrances information, etc.

The land title deed can be found in a land register that may be maintained by an authority. Information pertaining to the land title deed may be obtained from the land register, which otherwise from the owner himself who will possess a copy of the land title deed. However, ownership information, encumbrances information, etc. may change and increase over the years. These may therefore lead to an increase number of documents held by the owner or even lead to a risk of losing the documents that may be found in the land title deed.

The land title deed may also provide security of land ownership to the owner. The owner may also use the land title deed to seek for loans from financial institutions, banks, etc. As such, the land title deeds may be forged or replicated by counterfeiters for exploitation.

Therefore, there is a need for a land title deed with added security features against un-authorized forgery or replication, etc. There is also a need to minimize the risk of losing the documents relating to the land title deed and to also decrease the number of documents that may be held in possession by the owner.

### SUMMARY

In one aspect of the present invention, there is an electronic land title deed that comprises a number of flat sheets; and a smart chip embedded within the flat sheet, wherein the smart chip stores a number of data that provides information related to a land title deed.

In one embodiment, the electronic land title deed further includes an embedded antenna that is attached to the smart chip.

In another embodiment, the flat sheet may be made of any material such as a piece of paper, plastic, etc.

In yet another embodiment, the smart chip may prevent the electronic land title deed from being falsified, mistreated by an unauthorized party, etc.

In another embodiment of the present invention, the data stored in the electronic land title deed may include information such as estate and land description, ownership information, encumbrances information, etc.

In yet another aspect of the present invention, the electronic land title deed communicates through a communication protocol to a remote reader, the remote reader then communicates with a host that is provided with a software that converts the data stored in the smart chip into a readable format.

In another embodiment of the present invention, the remote reader is a device that is used for communicating with the smart chip embedded in the flat sheet of the electronic land title deed.

In one embodiment, the host may be a computer, a tablet, or any other known electronic device with a display screen.

In yet another embodiment of the present invention, the software is provided from a land register, wherein the owner may use the software to view the information retrieved from the electronic land title deed, and/or print the information accordingly.

### BRIEF DESCRIPTION OF THE DRAWINGS

This invention will be described by way of non-limiting embodiments of the present invention, with reference to the accompanying drawings, in which:

FIG. 1 illustrates an overall view of an electronic land title deed as one embodiment in the present invention;

FIG. 2 illustrates a schematic diagram showing a data communication flow between the electronic land title deed and a user through a receiver as another embodiment in the present invention;

FIG. 3A shows an exemplary illustration of the information that may be retrieved from the electronic land title deed and displayed on the host;

FIG. 3B shows another exemplary illustration of the information that may be retrieved from the electronic land title deed and displayed on the host;

FIG. 4 illustrates a block diagram of the smart chip of FIG. 1 in accordance with one embodiment of the present invention;

FIG. 5 illustrates a key management lifecycle of the tagging device in accordance with one embodiment of the present invention;

FIG. 6 illustrates an enrolment process in accordance with one embodiment of the present invention; and

FIG. 7 illustrates a eDeed issuance diagram in accordance with one embodiment of the present invention.

### DETAILED DESCRIPTION

The following descriptions of a number of specific and alternative embodiments are provided to understand the inventive features of the present invention. It shall be apparent to one skilled in the art, however that this invention may be practiced without such specific details. Some of the details may not be described in length so as to not obscure the invention. For ease of reference, common reference numerals will be used throughout the figures when referring to same or similar features common to the figures.

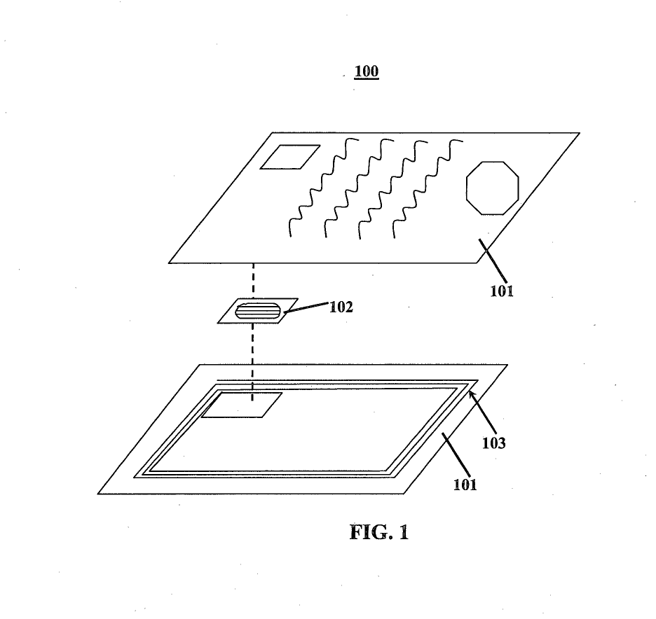

FIG. 1 illustrates an electronic land title deed 100 as one embodiment in the present invention. The electronic land title deed 100 comprises two or more flat sheets 101 and a smart chip 102 embedded/sandwiched between at least two of the flat sheets 101. The flat sheets 101 may be made of any material such as a piece of paper, plastic, etc. The smart chip 102 may be an inlay module having volatile memory and microprocessor components. The electronic land title deed 100 further includes an embedded antenna 103 that is attached to the smart chip 102. The embedded antenna 103 transmits or receives electromagnetic waves.

In another embodiment, the antenna 103 may be embedded on the inlay with the other components.

The electronic land title deed 100 contains data related to a land title of a particular plot of land. More specifically, the data is stored on the smart chip 102. The land title deed 100 also includes all the legal transactions or histories in relation to the plot of land. The legal transactions may also include landed properties, such as bungalows and terrace houses; flats; and commercial and industrial properties. These information are typically available a land title register that may be maintained by an authority. More importantly, the land title deed shall contains an owner's name, past and current one.

All of the information with regards to the land title deed may be imprinted on the surface of the land title deed as an ordinary deed issued by the relevant authority. Further, the general appearance on the surface of the flat sheet 101 of the electronic land title deed 100 can be also be identical to the ordinary land title deed. Apart from the information that can be visually presented on the flat sheet of the electronic land title deed 100, the information may also be encoded and stored on the smart chip 102 that is embedded within the flat sheet of the electronic land title deed 100.

In another embodiment of the present invention, the data that can be stored in the smart chip 102 includes estate and land description, ownership information, encumbrances information etc. Similarly, the information that may be obtained from the smart chip 102 should be in line with the information that can be visually seen on the flat sheet 101 of the electronic land title deed 100.

The estate and land description may describe the lot number, area, land tenure, etc. It may even comprise an image of the blue print of the plot of land, which is readable on any computing device. For the land tenure, information shown may include the state title number, date of the state title, commencement date of state lease and duration of state lease. The ownership information provides the basic information such as the owner's full name and last known living address, citizenship, identities, etc. Encumbrances information includes information that affects the property or the plot of land such as charges, mortgages, caveats and orders of court as well as state land encroachment.

As the information is securely stored on the smart chip 102, it is can be read or extracted through authorized reader. It is well known in the art that smart chip is provided with strong security authentication for protecting the information stored therein and it is proven. It is also used widely for authenticate identify. Accordingly, only the relevant authorities equipped with the authorized reader/writer are allowed to modify the information in the electronic land title deed 100. Non-authorized parties may be able to retrieve some or all of the information stored on the smart chip for viewing only, but they are not allowed to make any changes on the smart chip. Accordingly, even if a person is capable of tempering the information that are visually printed or engraved on the flat sheets of the electronic land title deed 100, he won't be able to make any changes to the information stored on the smart chip. The information altered on the flat sheet will therefore not able to conform to the information contained on the smart chip when the electronic land title deed be undergoing a verification.

Further, the smart chip 102 embedded in the flat sheet 101 of the electronic land title deed 100 may also include a security element such as a security hologram etc. The smart chip 102 may also prevent the electronic land title deed 100 from being falsified or mistreated by any unauthorized party. As such, the authenticity of the electronic land title deed 100 can be certified and proven to be a genuine copy.

In the above embodiment, the data that may be retrieved from the electronic land title deed 100 as provided above is by way of example and it is not intended to be limited to the scope of the present invention. Any other information that may be required or found in the land title deed may also be stored as data in the smart chip embedded in the flat sheet of the electronic land title deed.

In another embodiment of the present invention, the electronic land title deed 100 may be issued in a booklet form that comprises multiple flat sheets 101 that are bound together along one side of the flat sheet 101.

In yet another embodiment of the present invention, the electronic land title deed 100 may also be presented in a card type, resembling a credit card, an identification card, etc.

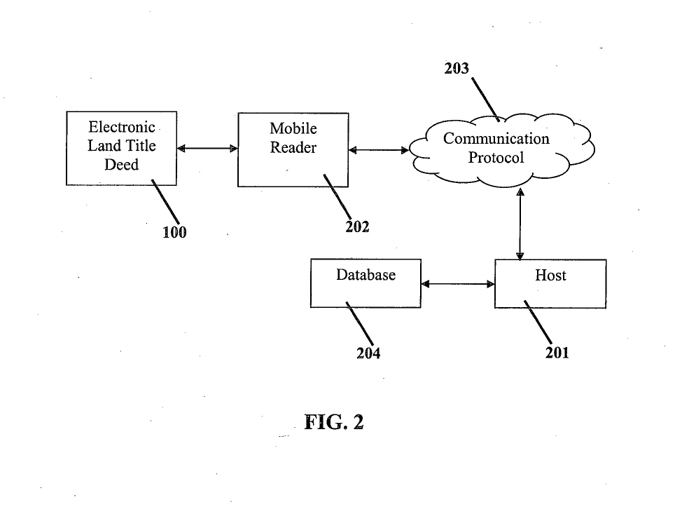

FIG. 2 illustrates a schematic diagram showing land title deed register network as another embodiment in the present invention. The network comprises a host 201 having a database 204, and a mobile reader 202 for reading and scanning the electronic land title deed 100. The smart chip 102 embedded within the flat sheet 101 of the electronic land title deed 100 communicates through the embedded antenna 103 with the mobile reader 202. For field usage, the mobile reader 202 is only capable of reading some of the information stored on the electronic land title deed 100. The relevant information extracted from the smart chip of the electronic land title deed 100 will be displayed on the mobile reader 202, and this information can be used to match against the visible information presented on the electronic land title deed 100 for a first level verification.

The mobile reader 202 upon reading the information stored on the electronic land title deed 100 may communicate with a host 201 to retrieve the information store on the database 204 for matching through a mobile communication network 203. The host 201 is resided at the relevant authority, or a trusted network that authorized to host the relevant information. Accordingly, such network allows the authorized officer to verify if the electronic land title deed 100 or the smart chip of the electronic land title deed 100 is a genuine one. This provides a second level of verification.

The mobile reader 202 may further comprise a fingerprint scanner or biometric scanner. With the scanner, the on-site officer can further verify if the person holding the electronic land title deed is the truthful holder through matching the person's fingerprint with the biometric information stored on the smart chip on-site. This provides a further level of verification for the land title deed.

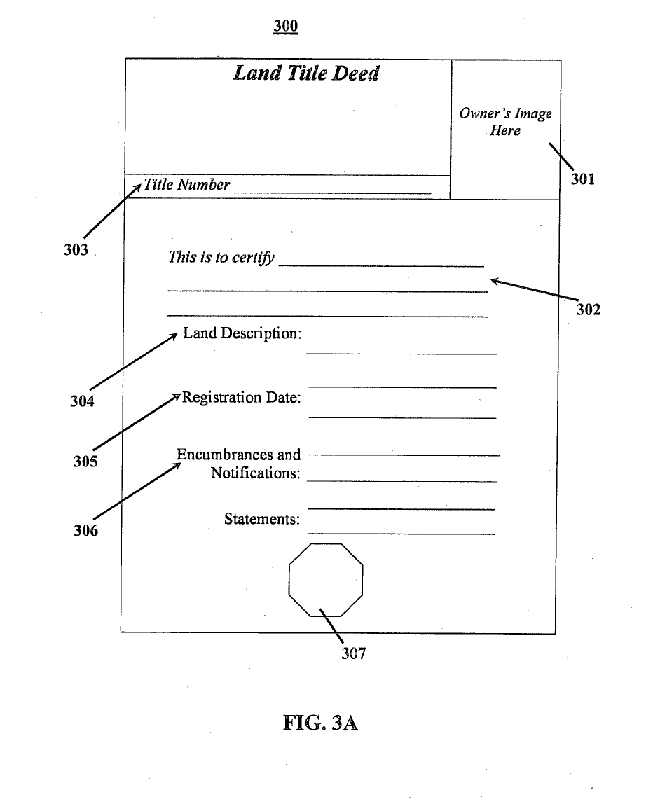

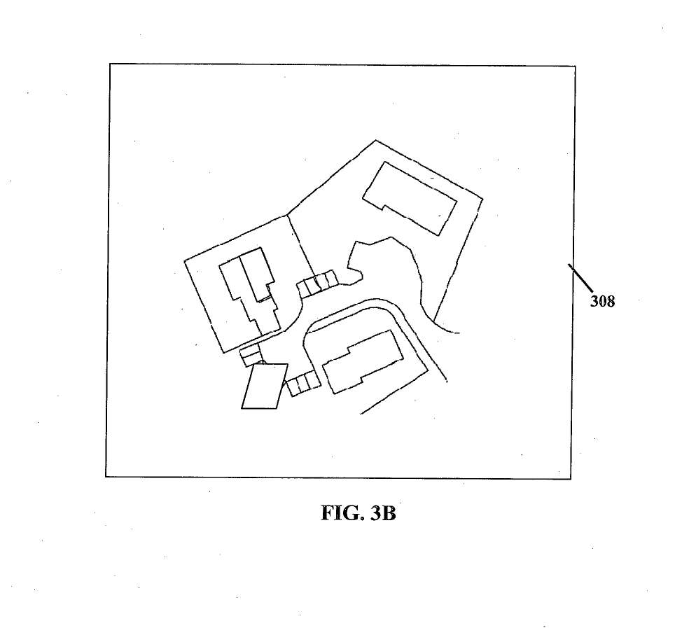

FIG. 3A shows an exemplary illustration of the information that may be retrieved from the electronic land title deed and displayed on the host. Referring to FIG. 3A, the information that may be displayed on the host may include an image of a land title deed 300 for a particular plot of land. The land title deed 300 may also include an image 301 of a person who owns the land title deed 300, ownership information 302, a title number 303, land description 304, a registration date 305, encumbrances information 306, an authorized stamp 307 that is certified by an authority from a land register, etc.

FIG. 3B shows another exemplary illustration of the information that may be retrieved from the electronic land title deed and displayed on the host. More specifically, FIG. 3 provides a schematic land diagram 308 of the particular plot of land.

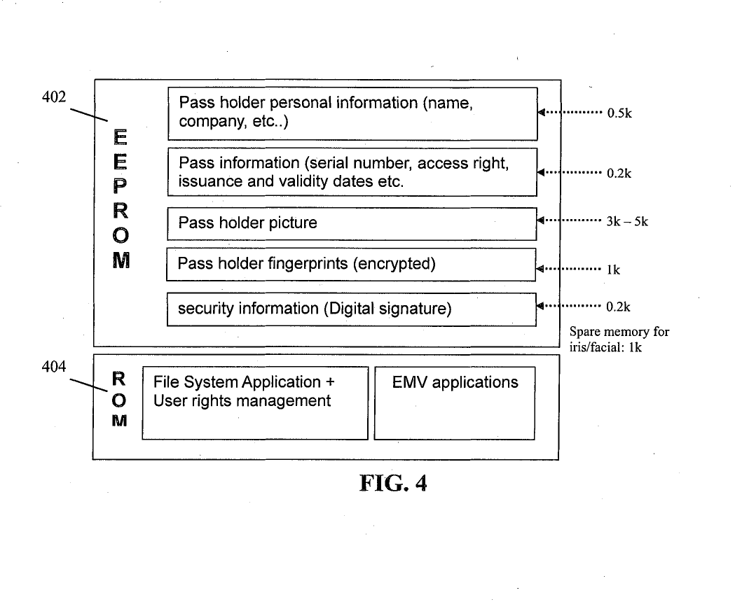

FIG. 4 illustrates a block diagram of the smart chip 102 of FIG. 1 in accordance with one embodiment of the present invention. The smart chip 102 can be a secured contactless chip. The data is stored on the chip in a ISO flexible file system. Various file systems are available such as ICAO LDS. The smart chip 102 comprises a EEPROM 402 and a ROM 404. The EEPROM 402 may reserved about 0.5K Bytes for personal information of the holder, such as name, company's name and etc. About 0.2K Bytes may be reserved for identity of the smart chip 102 such as serial number, access right, validity dates and etc. About 3K-5K Bytes may be reserved for holder picture in digital data form. About 1K Bytes may be reserved for the holder's biometric data such as finger print, etc., and about 0.2K Bytes may be reserved for security information such as digital signature. Preferably, the secured contactless chip shall be at least CC EAL4+ certified. It may also be FIPS 140 based chip, such as FIPS 140-2 Level 3 chip. The EEPROM 402 may further provide some spare memory, when necessary. The ROM 404 stored the required applications therein, such as file system application and user right manager, and EMC applications, or other e-pass applications. The applications may be Java applications supporting EAC (Extended Access Control) similar to that defined in the ICOA standard.

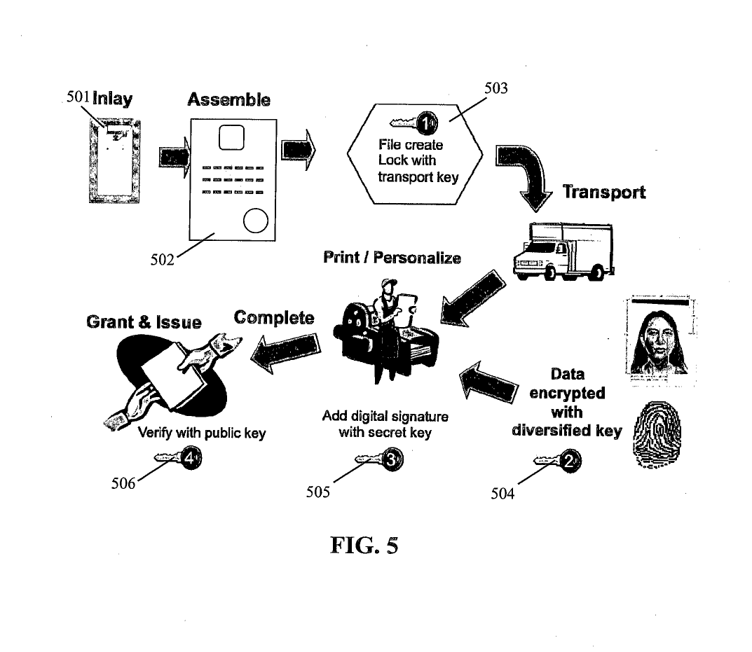

FIG. 5 illustrates a key management lifecycle of the eDeed in accordance with one embodiment of the present invention. The process starts with fabricating an inlay 501 of secure digital chip or smart chip. The secure digital chip can be a contactless smart chip or the like. Once it is fabricated, it is being assembled into a electronic Deed (eDeed) 502. The eDeed 502 is formed by having at least two flat sheets sandwiching the, inlay 501 as well as the connected antenna there between. The inlay 501 is fabricated with the secure digital chip with a file lock having a transport key 503 before actual informations is being embedded therein. The eDeed 502 will then be delivered and distributed to the on-site authority for granting and issuing the eDeed to the deed holder. The on-site authority inputs the relevant information into each eDeed. The information are stored on the eDeed encrypted with diversified key 504. The information may include the holder's picture(s), thumbprint, etc. which are enrolled with the authority. Once the encrypted information of the deed holder is stored on the respective eDeed, the eDeed may further engrave or print with the visible information on the eDeed as of an ordinary deed issued by the relevant authority. Over at the on-site authority, the informations are also encrypted with a digital signature with a secret key 505 to protect the information stored therein. Once the eDeed is granted and issued, it can be verified through a public key 506 with the authorized reader. The reader can be a Secure Access Module (SAM) based reader for reading the eDeed.

In an alternate embodiment, the secure digital chip may adopt a security standard similar to that adapted on e-Passport specification defined under International Civil Aviation Organisation (ICAO) or the like. It is also possible that other standard or protocols can also be adapted for the current wearable tagging device.

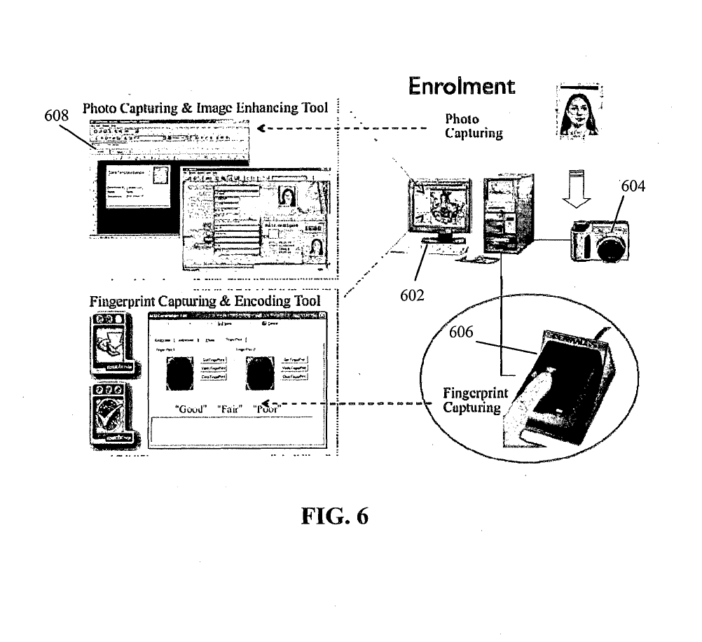

FIG. 6 illustrates an enrolment process in accordance with one embodiment of the present invention. The enrolment process requires an enrolment station 602 which has an imaging device 604 and a biometric reader 606. The enrolment station 602 can be any workstation or personal computer with an enrolment application 608 installed. The imaging device 604 can be any digital camera and the biometric reader can be a commercially available fingerprint reader for capturing fingerprint. If other biometric information is required, an appropriate biometric reader or scanner can be utilised. The enrolment application deployed on the enrolment station 602 may adapt known imaging tools to enhance the image captured through the imaging device 604. Similarly, the fingerprint capturing tool can be used to capture a desirably good quality image of the fingerprint and the biometric information shall be captured and encoded for storing on the chip.

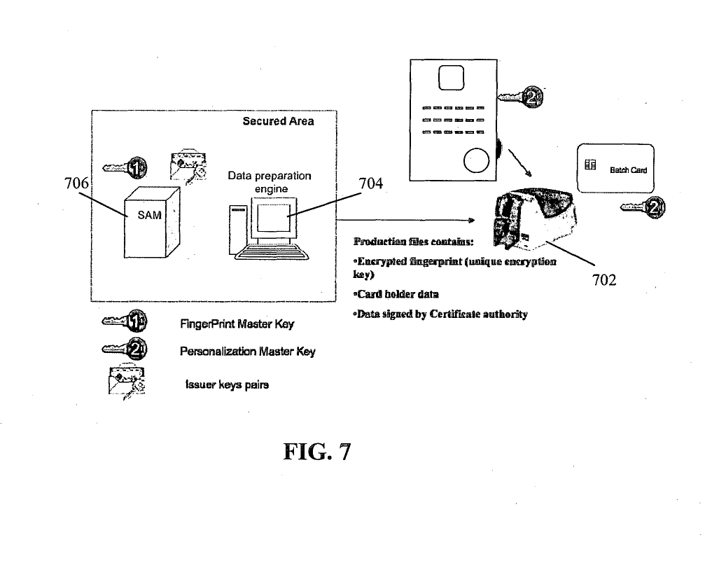

FIG. 7 illustrates a eDeed issuance diagram in accordance with one embodiment of the present invention. The eDeed issuance is provided with a eDeed writer 702 to write the required information into the smart chip of the eDeed. Preferably, the data is written into the smart chip wirelessly. The eDeed writer 702 includes a data preparation engine 704 and a SAM module 706 for operationally acquiring the required information from the on-site authority, preparing the data which include encryption with unique encryption key, and writing the same onto the chip of the eDeed with a fingerprint master key and an issuer keys pair. The data is also written onto the device with a personalised master key. The data will be signed by a certificate authority.

One will appreciate that the eDeed is capable to deploy other applications thereto. It can be used for any applications that an ordinary smart card can be used for, such as door access, payment application where ID is required, and etc.

The above description illustrates various embodiments of the present invention along with examples of how aspects of the present invention may be implemented. While specific embodiments have been described and illustrated it is understood that many charges, modifications, variations and combinations thereof could be made to the present invention without departing from the scope of the present invention. The above examples, embodiments, instructions semantics, and drawings should not be deemed to be the only embodiments, and are presented to illustrate the flexibility and advantages of the present invention as defined by the following claims:

1. An electronic land title deed comprising:
a plurality of flat sheets; and
a smart chip embedded within the flat sheet, wherein the smart chip stores a number of data that provides information related to a land title deed.

2. The electronic land title deed according to claim 1, wherein the electronic land title deed further includes an embedded antenna that is attached to the smart chip.

3. The electronic land title deed according to claim 1, wherein the flat sheet may be made of any material such as a piece of paper, plastic, etc.

4. The electronic land title deed according to claim 1, wherein the smart chip may prevent the electronic land title deed from being falsified, mistreated by an unauthorized party, etc.

5. The electronic land title deed according to claim 1, wherein the data stored in the electronic land title deed may include information such as estate and land description, ownership information, encumbrances information, etc.

6. The electronic land title deed according to claim 1, wherein the electronic land title deed communicates through a communication protocol to a remote reader, the remote reader then communicates with a host that is provided with a software that converts the data stored in the smart chip into a readable format.

7. The electronic land title deed according to claim 6, wherein the remote reader is a device that is used for communicating with the smart chip embedded in the flat sheet of the electronic land title deed.

8. The electronic land title deed according to claim 6, wherein the host may be a computer, a tablet, or any other known electronic device with a display screen.

9. The electronic land title deed according to claim 6, wherein the software is provided from a land register, wherein the owner may use the software to view the information retrieved from the electronic land title deed, and/or print the information accordingly.
